(19) United States
(12) Patent Application Publication
(10) Pub. No.: US 2017/0010503 A1
(43) Pub. Date: Jan. 12, 2017

(54) REFLECTIVE LIQUID CRYSTAL DISPLAY DEVICE AND METHOD OF MANUFACTURING THE SAME

(71) Applicant: Samsung Display Co. Ltd., Yongin-city (KR)

(72) Inventors: Jun Ho SONG, Seongnam-si (KR); Seung Hyun PARK, Seoul (KR); Sung Jin KIM, Seongnam-si (KR); Sung In RO, Hwaseong-si (KR); Young Jin PARK, Suwon-si (KR); Jong Hwan PARK, Gimhae-si (KR); Ock Soo SON, Seoul (KR); Yeo Geon YOON, Suwon-si (KR); Jae Hak LEE, Suwon-si (KR); Woong Ki JEON, Yongin-si (KR)

(21) Appl. No.: 15/012,598

(22) Filed: Feb. 1, 2016

(30) Foreign Application Priority Data
Jul. 6, 2015 (KR) 10-2015-0095972

(51) Int. Cl. G02F 1/1335; G02F 1/1368; G02F 1/1339; G02F 1/1362

(52) U.S. Cl. CPC G02F 1/133514; G02F 1/133553; G02F 1/136286; G02F 1/1368; G02F 1/133512; G02F 1/133516; G02F 1/13394; G02F 2001/136295

(57) ABSTRACT

A reflective liquid crystal display device is provided. A reflective liquid crystal display device comprising: a first substrate and a second substrate facing each other; a liquid crystal layer interposed between the first substrate and the second substrate; a plurality of gate lines and a plurality of data lines disposed on the first substrate and intersecting each other so as to define unit pixels; a reflective layer disposed on the gate lines and the data lines; and a color filter disposed on the reflective layer, wherein the color filter includes a red color filter, a green color filter and a blue color filter, wherein the blue color filter has an area larger than an area of the red color filter and an area of the green color filter, and wherein the blue color filter extends to a blue pixel region and a pixel region adjacent to the blue pixel region.

This application claims priority to Korean Patent Application No. 10-2015-0095972 filed on Jul. 6, 2015 in the Korean Intellectual Property Office, the disclosure of which is incorporated herein by reference in its entirety.

### BACKGROUND

1. Technical Field

The present inventive concept relates to a reflective liquid crystal display device and a method of manufacturing the same.

2. Description of the Related Art

In general, a liquid crystal display panel includes a lower substrate on which pixel electrodes are provided, an upper substrate on which a common electrode is provided, and a liquid crystal layer interposed between the two substrates. When voltages are applied to the pixel electrodes and the common electrode, the alignment of liquid crystal molecules in the liquid crystal layer change, thereby controlling light transmittance and displaying desired images.

Liquid crystal display devices may be categorized as non-emissive display devices that cannot emit light by themselves. Accordingly, a transmissive liquid crystal display device generally includes a backlight assembly for providing light to a liquid crystal display panel. However, the backlight assembly has problems of large power consumption and increased thickness and weight of the device. Specifically, portable devices such as an electronic book or an electronic newspaper need to be thinner, lighter and lower in power consumption. Therefore, the drawbacks of the backlight assembly such as large power consumption and increased weight may weaken the competitiveness of the liquid crystal display devices.

Unlike a transmissive liquid crystal display device, a reflective liquid crystal display device controls light transmittance by reflecting natural light or artificial light from an external source through the use of a reflector without using a separate backlight assembly. Therefore, the reflective liquid crystal display device has advantages of lighter weight and lower power consumption as compared with the transmissive liquid crystal display device, and thus the reflective liquid crystal display device may be more suitable for an electronic book.

The reflector used in a conventional reflective liquid crystal display device may have reddish or yellowish reflection characteristics when compared with white paper, which may cause a user a sense of difference between viewing the screen of the reflective liquid crystal display device and viewing paper.

### SUMMARY

An embodiment of the present inventive concept provides a reflective liquid crystal display device capable of realizing a color sense similar to those of actual paper and a method of manufacturing the same.

According to an embodiment of the present inventive concept, there is provided a reflective liquid crystal display device capable of realizing a color sense similar to those of actual paper.

According to another embodiment of the present inventive concept, there is provided a method of manufacturing a liquid crystal display device capable of realizing a color sense similar to those of actual paper.

However, effects of the embodiments of the present inventive concept are not restricted by the features set forth herein and more diverse effects are included in this description.

According to an aspect of the present invention, there is provided a reflective liquid crystal display device comprising: a first substrate and a second substrate facing each other; a liquid crystal layer interposed between the first substrate and the second substrate; a plurality of gate lines and a plurality of data lines disposed on the first substrate and intersecting each other so as to define unit pixels; a reflective layer disposed on the gate lines and the data lines; and a color filter disposed on the reflective layer, wherein the color filter includes a red color filter, a green color filter and a blue color filter, wherein the blue color filter has an area larger than an area of the red color filter and an area of the green color filter, and wherein the blue color filter extends to a blue pixel region and a pixel region adjacent to the blue pixel region.

The pixels defined by the plurality of gate lines and the plurality of data lines may have a uniform size.

The blue color filter may be overlapped with two or more thin film transistors in pixel regions adjacent to the blue pixel region.

The area of the red color filter and the area of the green color filter may be the same.

The color filter further includes a white color filter, and the area of the blue color filter may be larger than an area of the white color filter.

The area of the red color filter and the area of the green color filter may be larger than the area of the white color filter.

The color filter may further include a white color filter, and the area of the blue color filter is the same as an area of the white color filter.

The color filter may further include a white color filter, and the red color filter, the green color filter, the blue color filter and the white color filter may be arranged in two columns by two rows configuration, and the blue color filter and the white color filter may be disposed in the same row.

The reflective liquid crystal display device may further include a first organic layer and a second organic layer, wherein the reflective layer is disposed on the first organic layer, and the second organic layer is disposed on the color filter.

The reflective liquid crystal display device may further include a light blocking member disposed on the second substrate, wherein the light blocking member is disposed on a region corresponding to a boundary between the color filters.

The reflective liquid crystal display device may further include a common electrode disposed on the second substrate, wherein the common electrode and the reflective layer may have same electrical potential.

According to another aspect of the present invention, there is provided a method of manufacturing a reflective liquid crystal display device, the method comprising: forming a plurality of gate lines and a plurality of data lines intersecting each other on a first substrate so as to define unit pixels; forming a reflective layer on the gate lines and the data lines; and forming a color filter on the reflective layer, wherein the color filter may include a red color filter, a green color filter and a blue color filter, wherein the blue color filter may have an area larger than an area of the red color filter and an area of the green color filter, and wherein the blue color filter may be formed in a blue pixel region and a pixel region adjacent to the blue pixel region.

The pixels defined by the plurality of gate lines and the plurality of data lines may have a uniform size.

The blue color filter may be overlapped with two or more thin film transistors in pixel regions adjacent to the blue pixel region.

The color filter may further include a white color filter, and the area of the blue color filter is larger than an area of the white color filter.

The method of manufacturing a reflective liquid crystal display device may further including: forming a first organic layer on the gate lines and the data lines; and forming a second organic layer on the color filter.

The method of manufacturing a reflective liquid crystal display device may further including: forming a pixel electrode on the second organic layer.

The method of manufacturing a reflective liquid crystal display device may further including: forming a common electrode on a second substrate; and forming a light blocking member on the common electrode, wherein the light blocking member is disposed on a region corresponding to a boundary between the color filters.

The method of manufacturing a reflective liquid crystal display device may further including: forming a column spacer on the light blocking member.

The light blocking member and the column spacer may be formed integrally with each other.

### BRIEF DESCRIPTION OF THE DRAWINGS

FIG. 1 is a layout diagram of a reflective liquid crystal display device according to an embodiment of the present inventive concept;

FIG. 2 is a cross-sectional view taken along line II-II′ of FIG. 1;

FIG. 3 is a cross-sectional view taken along line III-III′ of FIG. 1;

FIG. 4 is a plane view illustrating a structure of a color filter of the reflective liquid crystal display device according to an embodiment of the present inventive concept;

FIGS. 5, 6, 7, 8, 9, 10, 11, 12, 13, 14, 15, 16 and 17 are cross-sectional views illustrating intermediate process steps of a method of manufacturing the liquid crystal display device according to an embodiment of the present inventive concept;

FIG. 18 is a plane view illustrating a structure of a color filter of the reflective liquid crystal display device according to another embodiment of the present inventive concept;

FIG. 19 and FIG. 20 are plane views illustrating structures of color filters of the reflective liquid crystal display devices respectively according to other of the present inventive concept;

FIG. 21 is layout diagram of a reflective liquid crystal display device according to other embodiment of the present inventive concept; and

FIG. 22 and FIG. 23 are plane views illustrating structures of color filters of reflective liquid crystal display devices according to yet still another embodiment of the present inventive concept.

### DETAILED DESCRIPTION OF THE EMBODIMENTS

Reference will now be made in detail to exemplary embodiments, examples of which are illustrated in the accompanying drawings, wherein like reference numerals refer to like elements throughout the specification. In this regard, the present exemplary embodiments may have different forms and should not be construed as being limited to the descriptions set forth herein. Accordingly, the exemplary embodiments are merely described below, by referring to the figures, to explain aspects of the present description.

The description that one element is connected to or coupled to another element includes both a case where the one element is directly connected to the another element or a case where further another element is interposed between the elements. However, the description that one element is directly connected or directly coupled to another element indicates that there is no further element between the elements. The term “and/or” includes any and all combinations of one or more of the associated listed items.

A singular expression in the present specification also includes a plural expression. The terms “comprise” and/or “comprising” do not exclude the possibility of existence or addition of one or more other components, steps, operations, and/or devices.

Embodiments of the present inventive concept will now be described in detail with reference to the drawings.

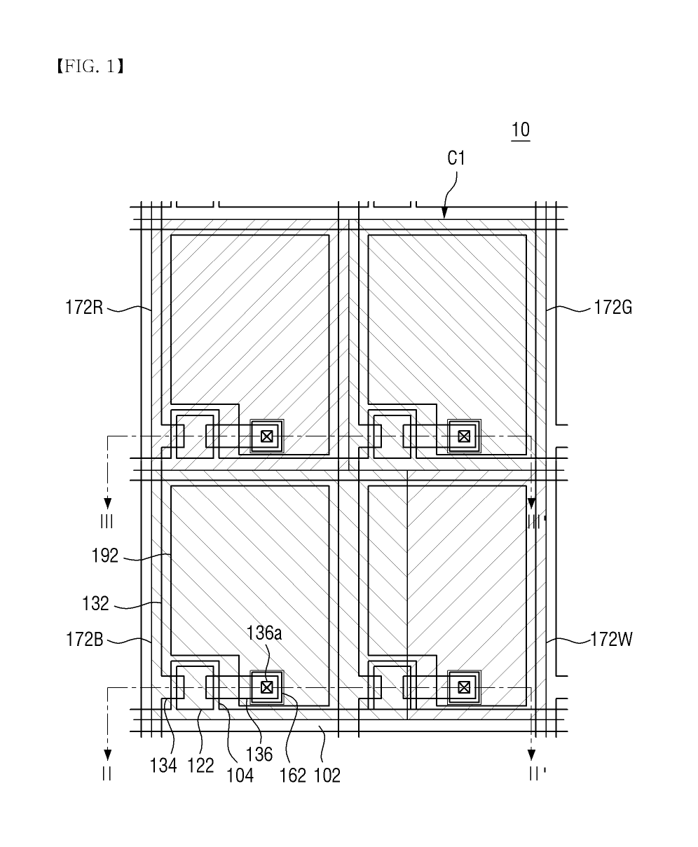

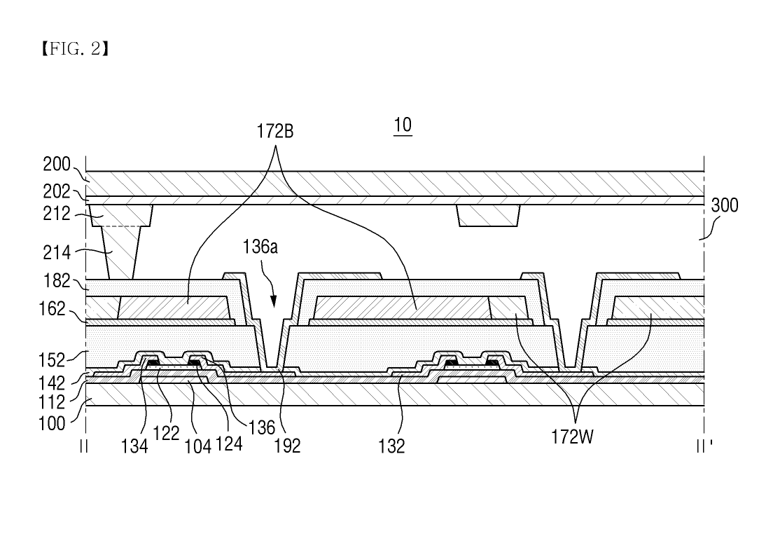

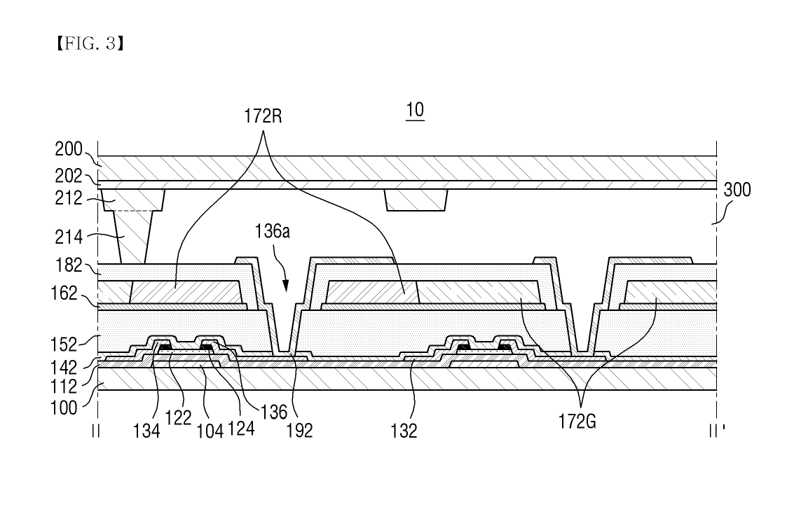

FIG. 1 is a layout diagram of a reflective liquid crystal display device according to an embodiment of the present inventive concept. FIG. 2 is a cross-sectional view taken along line II-II′ of FIG. 1. FIG. 3 is a cross-sectional view taken along line III-III′ of FIG. 1. FIG. 4 is a plane view illustrating a structure of a color filter of the reflective liquid crystal display device according to an embodiment of the present inventive concept.

Referring to FIG. 1 to FIG. 3, a reflective liquid crystal display device 10 according to an embodiment of the present inventive concept may include a first substrate 100 and a second substrate 200 facing each other, and a liquid crystal layer 300 interposed between the first substrate 100 and the second substrate 200.

The first substrate 100 and the second substrate 200 may include an insulating material such as transparent glass, plastic, quartz, ceramic or silicon, and the insulating material can be selected appropriately as needed by a person skilled in the art. The first substrate 100 and the second substrate 200 may face each other.

A plurality of gate wirings 102 and 104 and a plurality of data wirings 132, 134 and 136 may be disposed on the first substrate 100.

The gate wirings 102 and 104 may include a plurality of gate lines 102 and a plurality of gate electrodes 104. The data wirings 132, 134 and 136 may include a plurality of data lines 132, a plurality of source electrodes 134 and a plurality of drain electrodes 136.

The gate wirings 102 and 104 and the data wirings 132, 134 and 136 may be made of aluminum-based metal such as aluminum (Al) and aluminum alloy, silver-based metal such as silver (Ag) and silver alloy, copper-based metal such as copper (Cu) and copper alloy, molybdenum-based metal such as molybdenum (Mo) and molybdenum alloy, chrome (Cr), titanium (Ti), tantalum (Ta) and the like. Furthermore, the gate wirings 102 and 104 and the data wirings 132, 134 and 136 may have a multi-layer structure including two conductive layers (not shown) having different physical properties. For example, one conductive layer may be made of aluminum-based metal, silver-based metal, copper-based metal and the like, and the other conductive layer may be made of molybdenum-based metal, chrome (Cr), titanium (Ti), tantalum (Ta) and the like. An example of such combination may include a lower layer made of chrome and an upper layer made of aluminum, and a lower layer made of aluminum and an upper layer made of molybdenum. However, the present disclosure is not limited thereto, and the gate wirings 102 and 104 and the data wirings 132, 134 and 136 may be made of various metals and conductors.

Each gate line 102 may extend along a boundary between pixels in a first direction, for example, a horizontal direction, and each data line 132 may extend along a boundary between pixels in a second direction, for example, a vertical direction. The plurality of gate lines 102 and the plurality of data lines 132 may intersect each other so as to define unit pixels. Pixels may be defined by regions enclosed by the gate lines 102 and the data line 132. The pixels defined by the plurality of gate lines 102 and the plurality of data lines 132 may have a constant/uniform size. However, these are merely exemplary, and the present disclosure is not limited thereto.

Each gate line 102 may have at least one gate electrode 104 disposed in the unit pixel and electrically connected to a pixel electrode. The gate electrode 104 may be formed by being branched from the gate line 102 toward a semiconductor layer 122 or by extending the gate line 102 toward the semiconductor layer 122. However, the present disclosure is not limited thereto, and the gate electrode 104 may be defined in a region where the semiconductor layer 122 overlaps the gate line 102.

Each data line 132 may have at least one source electrode 134 disposed on the semiconductor layer 122 and electrically connected to a pixel electrode. The source electrode 134 may be formed by being branched from the data line 132 toward the semiconductor layer 122 or by extending the data line 132 toward the semiconductor layer 122. However, the present disclosure is not limited thereto, and the source electrode 134 may be defined in a region where the semiconductor layer 122 overlaps the data line 132. The drain electrode 136 may be spaced apart from the source electrode 134 with the semiconductor layer 122 interposed therebetween, and may be electrically connected to a pixel electrode 192 via a contact hole 136a formed through a first passivation layer 142 and a second passivation layer 172.

A gate insulation layer 112 may be interposed between the gate wirings 102 and 104 and data wirings 132, 134 and 136. In one embodiment, the gate insulation layer 112 may be disposed on the gate wirings 102 and 104, and the data wirings 132, 134 and 136 may be disposed on the gate insulation layer 112. The gate insulation layer 112 may be made of, for example, silicon nitride (SiNx), silicon oxide (SiO2), silicon oxynitride (SiON), a combination thereof and the like. The gate insulation layer 112 may serve to maintain insulation from conductive thin films such as gate wirings 102 and 104 and data lines 132 provided on the gate wirings 102 and 104.

The semiconductor layer 122 may be disposed on the gate insulation layer 112, and made of, for example, hydrogenated amorphous silicon, polycrystalline silicon or the like. The semiconductor layer 122 may be disposed to be at least partially overlapped with the gate electrode 104. The semiconductor layer 122 may constitute a thin film transistor together with the gate electrode 104, the source electrode 134 and the drain electrode 136. In the embodiment described with reference to FIG. 1, the thin film transistor is disposed at a predetermined point in each pixel, however, the present disclosure is not limited thereto, and the thin film transistor may be disposed in a zigzag configuration along a pixel string.

The semiconductor layer 122 may have various shapes such as an island shape, a linear shape and the like, and FIG. 3 illustrates the semiconductor layer 122 having an island shape, but the present disclosure is not limited thereto. When the semiconductor layer 122 is formed into a linear shape, although not shown in the drawings, the semiconductor layer 122 may be overlapped with the data wirings 132, 134 and 136.

An ohmic contact layer 124 made of high concentration n-type impurities doped n+ hydrogenated amorphous silicon and the like may be disposed on the semiconductor layer 122. The ohmic contact layer 124 may be interposed between the semiconductor layer 122 and the source electrode 134 and the drain electrode 136 so as to reduce contact resistance. Similarly to the semiconductor layer 122, the ohmic contact layer 124 may have various shapes such as an island shape, a linear shape and the like. When the semiconductor layer 122 has an island shape, the ohmic contact layer 124 may also have an island shape, and when the semiconductor layer 122 has a linear shape, the ohmic contact layer 124 may also have a linear shape. Since the source electrode 134 and the drain electrode 136 are spaced apart from each other and facing each other with a disconnected space therebetween, the semiconductor layer 122 below the ohmic contact layer 124 may be exposed. The semiconductor layer 122 may have a channel formed in a region corresponding to the space between the source electrode 134 and the drain electrode 136 facing each other.

When a gate on signal is applied to the gate electrode 104 so as to form a channel in the semiconductor layer 122, then the thin film transistor may be turned on and the drain electrode 136 may receive a data signal from the source electrode 134 and transfer the data signal to the pixel electrode 192.

The first passivation layer 142 may be disposed on the data wirings 132, 134 and 136 and the exposed part of the semiconductor layer 122. The contact hole 136a for exposing at least a part of the drain electrode 136 may be formed in the first passivation layer 142 and a first organic layer 152 which will be discussed later. At least a part of the drain electrode 136 exposed through the contact hole 136a may contact the pixel electrode 192. Thus, the drain electrode 136 and the pixel electrode 192 may be electrically connected with each other.

In some embodiments, the contact hole 136a may be formed into a shape which exposes only a part of the drain electrode 136 as shown in FIG. 1 to FIG. 3. However, this is merely exemplary, and the contact hole 136a may be formed into a shape which exposes a part of the drain electrode 136 and a part of the gate insulation layer 112.

The first passivation layer 142 may include, for example, an inorganic substance such as silicon nitride or silicon oxide, a material formed by plasma enhanced chemical vapor deposition (PECVD), and the like.

The first organic layer 152 may be disposed on the first passivation layer 142. The first organic layer 152 may include a material having superior planarization characteristics and photosensitivity. The first organic layer 152 may include the contact hole 136a for exposing at least a part of the drain electrode 136.

A reflective layer 162 may be disposed on the first organic layer 152. The reflective layer 162 may serve to reflect light incident from an external source of light. To this end, the reflective layer 162 may include a highly reflective metal layer, for example, a silver (Ag) or aluminum (Al) metal layer, but the present disclosure is not limited thereto. The reflective layer 162 may be formed by stacking two or more metal layers or reflective layers.

The reflective layer 162 may include an aperture for interconnecting the pixel electrode 192 and the drain electrode 136. The aperture of the reflective layer 162 may be formed in every pixel. The aperture may have a size larger than the size of the contact hole 136a. In this case, the contact hole 136a may be positioned in the aperture formed in the reflective layer 162 as shown in FIG. 1. The reflective layer 162 may be formed into a single body all over the whole display area excluding the aperture. Since the gate line 102 and the data line 132 are covered by the reflective layer 162, an aperture ratio loss caused by the gate line 102 and the data line 132 may not occur or may be minimized.

A constant voltage may be applied to the reflective layer 162 such that a voltage fluctuation of the reflective layer 162 caused by the voltages applied to the gate line 102 and the data line 132 may not occur. For example, the reflective layer 162 may be electrically connected to a common electrode 202 disposed on the second substrate 200 so that a common voltage can be applied to the reflective layer 162. The reflective layer 162 and the common electrode 202 may be electrically connected with each other by the known conventional various methods thus have the same electrical potential, however, a detailed description thereof will be omitted.

Color filters 172R, 172G, 172B and 172W may be disposed on the reflective layer 162. The color filters 172R, 172G, 172B and 172W may include a red color filter 172R, a green color filter 172G, a blue color filter 172B and a white color filter 172W, respectively. Each of the red, green, blue and white color filters 172R, 172G, 172B and 172W may be disposed in one or more pixels. The color filters 172R, 172G, 172B and 172W may include a photosensitive organic material containing a pigment. In one embodiment, the white color filters 172W may be transparent layer.

The color filters 172R, 172G, 172B and 172W may include an aperture for an interconnection between the pixel electrode 192 and the drain electrode 136. The aperture may have a size larger than the size of the contact hole 136a. In this case, the contact hole 136a may be disposed in the aperture formed in the red, green, blue and white color filters 172R, 172G, 172B and 172W. Furthermore, the aperture of the color filters 172R, 172G, 172B and 172W may be larger than the aperture of the reflective layer 162, and the aperture of the reflective layer 162 may be disposed in the aperture of the color filters 172R, 172G, 172B and 172W, but the present disclosure is not limited thereto.

At least a part of the color filters 172R, 172G, 172B and 172W may be overlapped with the pixel electrode 192. Light incident from an external source may be reflected by the reflective layer 162 after being transmitted through the color filters 172R, 172G, 172B and 172W and, thereby displaying colors corresponding to the respective color filters 172R, 172G, 172B and 172W.

The structures of the color filters 172R, 172G, 172B and 172W will hereinafter be described.

A second organic layer 182 may be disposed on the color filters 172R, 172G, 172B and 172W. The second organic layer 182 may include a material having superior planarization characteristics and photosensitivity. The second organic layer 182 may include an aperture for an interconnection between the pixel electrode 192 and the drain electrode 136. The aperture may have a size larger than the size of the contact hole 136a formed on the drain electrode 136. In this case, the contact hole 136a may be disposed in the aperture formed in the second organic layer 182. The second organic layer 182 may be disposed on the color filters 172R, 172G, 172B and 172W so as to planarize stepped portions of the red, green, blue and white color filters 172R, 172G, 172B and 172W. The second organic layer 182 may cover the whole of the color filters 172R, 172G, 172B and 172W. That is, the color filters 172R, 172G, 172B and 172W may be covered by the second organic layer 182 such that no portions thereof may be exposed. However, these are merely exemplary, and the present disclosure is not limited thereto.

The second organic layer 182 may include a part directly contacting an upper surface of the first organic layer 152 as shown in FIG. 2. A part of the upper surface of the first organic layer 152 may not be covered by the second organic layer 182 as shown in FIG. 2. In other words, an inner surface of the contact hole 136a formed in the first organic layer and the second organic layer 182 may include a stepped portion. However, this structure is exemplary, and the whole upper surface of the first organic layer 152 may be covered by the second organic layer 182. In addition, if at least a part of the drain electrode 136 may be exposed through the contact hole 136a, the whole inner surface of the contact hole 136a formed in the first organic layer 152 may be covered by the second organic layer 182.

The pixel electrode 192 may be disposed on the second organic layer 182. The pixel electrode 192 may be disposed in every unit pixel. The pixel electrode 192 may not be overlapped with the thin film transistor. The pixel electrode 192 may be formed to have a uniform/constant size as shown in FIG. 1. More specifically, the pixel electrode 192 may be formed to have a uniform/constant size regardless of the sizes of the color filters 172R, 172G, 172B and 172W. In other words, the area of pixel electrode 192 disposed in each unit pixel may have a constant value in a plane view. However, these are merely exemplary, and the present disclosure is not limited thereto.

A part of the pixel electrode 192 may be disposed inside the contact hole 136a. The part of the pixel electrode 192 disposed inside the contact hole 136a may contact the drain electrode 136 and be electrically connected to the drain electrode 136. Although not shown in the drawings, when a part of the drain electrode 136 and a part of the gate insulation layer 112 are exposed by the contact hole 136a, the pixel electrode 192 may include a part directly contacting the gate insulation layer 112.

When a data voltage is applied to the pixel electrode 192, the pixel electrode 192 may cooperate with the common electrode 202 so as to generate an electric field therebetween to control the alignment direction of the liquid crystal molecules in the liquid crystal layer 300. The pixel electrode 192 may include a transparent conductive material such as ITO or IZO, but the present disclosure is not limited thereto.

The common electrode 202, a light blocking member 212 and a column spacer 214 may be disposed on the second substrate 200.

The common electrode 202 may be disposed on the surface of the second substrate 200 facing the first substrate 100. The common electrode 202 may be formed into a single body all over the whole pixel region. The common electrode 202 may be made of a transparent conductive material such as polycrystalline, single crystalline or amorphous indium tin oxide (ITO) or indium zinc oxide (IZO). The common electrode 202 may receive a common voltage applied thereto and cooperate with the pixel electrode 192 so as to generate an electric field therebetween to control the alignment direction of the liquid crystal molecules contained in the liquid crystal layer 300.

The common electrode 202 and the reflective layer 162 may be electrically connected with each other. The common electrode 202 and the reflective layer 162 may be electrically connected with each other by the known conventional various methods, however, a detailed description thereof will be omitted.

The light blocking member 212 may be disposed on the common electrode 202. The light blocking member 212 may serve to prevent light leakage between adjacent pixels. The light blocking members 212 may be disposed to correspond to respective boundaries among the red color filter 172R, the green color filter 172G, the blue color filter 172B and the white color filter 172W. Specifically, the light blocking members 212 may have a lattice configuration to correspond to respective boundaries. However, this arrangement of the light blocking members 212 is merely exemplary, and the present disclosure is not limited thereto. For example, the light blocking member 212 may be arranged into a line only among color filter columns. The light blocking member 212 may be made of a black organic polymer material including black dye or pigment, metal (metallic oxide) such as chrome and chrome oxide, or the like.

The column spacer 214 may serve to maintain a cell gap and may be formed on the light blocking member 212 as shown in FIG. 2 and FIG. 3. When the light blocking members 212 are arranged in the lattice configuration, the column spacers 214 may be disposed at intersecting points of the lattice. Furthermore, the column spacers 214 may be disposed at a part of the intersecting points rather than all of the intersecting points. However, this arrangement of the column spacers 214 is merely exemplary, and the present disclosure is not limited thereto.

In some embodiments, the column spacer 214 may be made of a material same as that of the light blocking member 212. Furthermore, the column spacer 214 may be formed integrally with the light blocking member 212. For example, the column spacer 214 and the light blocking member 212 may be formed of the same material through the same manufacturing process using a half tone mask or slit mask.

Although the light blocking member 212 is depicted as being disposed on the second substrate 200 in the embodiment described with reference to FIG. 2 and FIG. 3, but the present disclosure is not limited thereto, and the light blocking member 212 may be disposed on the first substrate 100. For example, the light blocking members 212 may be disposed to correspond to respective boundaries among the red color filter 172G, the green color filter 172G, the blue color filter 172B and the white color filter 172W on the second organic layer 182 of the first substrate 100.

An alignment layer (not shown) may be disposed on each of one side of the first substrate 100 and one side of the second substrate 200 facing toward the liquid crystal layer 300. That is, an alignment layer (not shown) for aligning the liquid crystal layer 300 may be disposed on the pixel electrode 192, the second organic layer 182, the common electrode 202, the light blocking member 212 and the column spacer 214.

The column spacer 214 may have an end contacting the first substrate 100.

The liquid crystal layer 300 including liquid crystal molecules (not shown) having a positive dielectric anisotropy or a negative dielectric anisotropy may be interposed between the first substrate 100 and the second substrate 200.

The structures of the color filters 172R, 172G, 172B and 172W according to an embodiment of the present inventive concept will now be described.

Referring to FIG. 1 to FIG. 4, the red color filter 172R and the green color filter 172G may be arranged repeatedly alternately in the same column in a plane view. The blue color filter 172B and the white color filter 172W may be arranged repeatedly alternately in another column, for example in the adjacent previous column and/or subsequent column. One combination C1 of the red, green, blue and white color filters 172R, 172G, 172B and 172W may have a tetragonal shape in a plane view. In other words, the combination C1 of the red, green, blue and white color filters 172R, 172G, 172B and 172W may be arranged into two columns by two rows configuration as shown in FIG. 4.

The one combination C1 of the red, green, blue and white color filters 172R, 172G, 172B and 172W may be repeatedly arranged in a row direction. The one combination C1 of the red, green, blue and white color filters 172R, 172G, 172B and 172W and another combination C2 of the red, green, blue and white color filters 172R, 172G, 172B and 172W may be alternately arranged in a column as shown in FIG. 4. However, the arrangement of the combination of the red, green, blue and white color filters 172R, 172G, 172B and 172W described above is merely exemplary, and various other arrangements may be applied to the present disclosure.

Each of the red, green, blue and white color filters 172R, 172G, 172B and 172W may include an aperture for an interconnection between the pixel electrode 192 and the drain electrode 136. The red, green, blue and white color filters 172R, 172G, 172B and 172W may be arranged consecutively as shown in FIG. 2 to FIG. 4. That is, a boundary of one color filter may contact a boundary of other color filters. Thus, the red, green, blue and white color filters 172R, 172G, 172B and 172W may be arranged consecutively all over the whole pixel region enclosed by the gate lines 102 and the data line 132, excluding the aperture.

The area of the blue color filter 172B may be wider than the area of the red color filter 172R, the area of the green color filter 172G and the area of the white color filter 172W in the combination C1 of the red, green, blue and white color filters 172R, 172G, 172B and 172W in a plane view. The area of the red color filter 172R and the area of the green color filter 172G may be wider than the area of the white color filter 172W in a plane view. The area of the red color filter 172R and the area of the green color filter 172G may be the same in the combination C1 of the red, green, blue and white color filters 172R, 172G, 172B and 172W in a plane view.

The area ratio of the red, green, blue and white color filters 172R, 172G, 172B and 172W may be determined in consideration of reflection characteristics of the reflective layer 162. For example, the area ratio of the red, green, blue and white color filters 172R, 172G, 172B and 172W may be approximately 1:1:1.2:0.8. That is, as the area of the blue color filter 172B may become relatively larger, the area of the white color filter 172W may become relatively smaller. When the pixel electrode 192 has a constant/uniform size regardless of the size of each of the color filters 172R, 172G, 172B and 172W as shown in FIG. 1, the blue color filter 172B may extend to a white pixel region adjacent to the blue pixel region. That is, the blue color filter 172B may be disposed in two adjacent pixel regions. More specifically, the blue color filter 172B may cover a blue pixel region (a first pixel) and a white pixel region (a second pixel) adjacent to the first pixel. Thus, as shown in FIG. 2, the blue color filter 172B may be overlapped with at least a part of a thin film transistor in the white pixel region. Furthermore, the blue color filter 172B may be overlapped with the data line 132 interposed between the blue pixel region and the white pixel region.

When the area of the red color filter 172R and the area of the green color filter 172G are the same as in the embodiment described with reference to FIG. 3 and FIG. 4, the red color filter 172R and the green color filter 172G may contact with each other in a region corresponding to the data line 132 interposed between the pixel electrode 192 corresponding to the red color filter 172R and the pixel electrode 192 corresponding to the green color filter 172G.

In the embodiment described with reference to FIG. 1 to FIG. 4, the red color filter 172R and the blue color filter 172B may contact with each other in a region corresponding to the gate line 102 interposed between the pixel electrode 192 corresponding to the red color filter 172R and the pixel electrode 192 corresponding to the blue color filter 172B.

In the embodiment described with reference to FIG. 1 to FIG. 4, the blue color filter 172B and the green color filter 172G may contact with each other in a region corresponding to the gate line 102 interposed between the pixel electrode 192 corresponding to the green color filter 172G and the pixel electrode 192 corresponding to the white color filter 172W.

In the embodiment described with reference to FIG. 1 to FIG. 4, the green color filter 172G and the white color filter 172W may contact with each other in a region corresponding to the gate line 102 interposed between the pixel electrode 192 corresponding to the green color filter 172G and the pixel electrode 192 corresponding to the white color filter 172W.

The reflective layer 162 of the reflective liquid crystal display device 10 may have reddish and yellowish reflection characteristics when compared with white paper. This may cause a user a sense of difference between viewing the screen of the reflective liquid crystal display device and viewing paper, and thus, as shown in FIG. 4, the area of the blue color filter 172B is formed wider than the area of the red color filter 172R and the area of the green color filter 172G, thereby mitigating the reddish and yellowish reflection characteristics of the reflective layer 162 and realizing a color sense similar to those of actual paper.

Furthermore, the luminance of light reflected through the white color filter 172W may be higher than the luminance of light reflected through the red color filter 172R, the green color filter 172G and the blue color filter 172B. Thus, the area of the white color filter 172W may be formed smaller than the area of the red color filter 172R, the green color filter 172G and the blue color filter 172B, thereby effectively mitigating the reddish and yellowish reflection characteristics of the reflective layer 162.

A method of manufacturing the reflective liquid crystal display device 10 according to an embodiment of the present inventive concept will hereinafter be described.

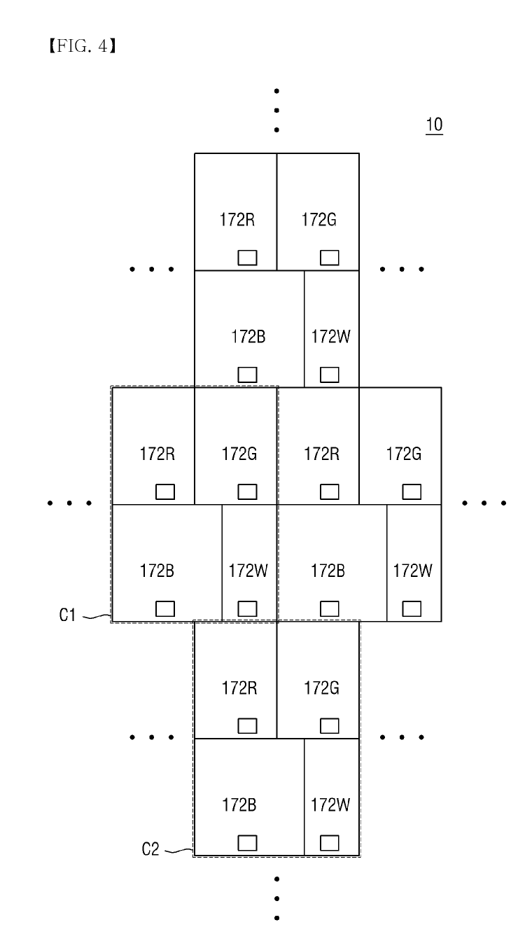

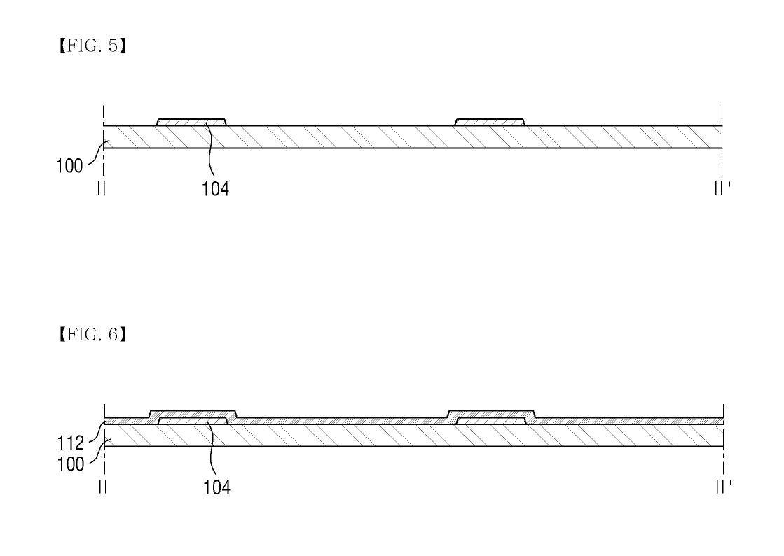

FIG. 5 to FIG. 17 are cross-sectional views illustrating intermediate process steps of a method of manufacturing the liquid crystal display device according to an embodiment of the present inventive concept.

First, referring to FIG. 1, FIG. 2 and FIG. 5, the gate wirings 102 and 104 may be formed on the first substrate 100.

A first metal layer (not shown) may be formed on the first substrate 100 including a transparent material, for example, glass, plastic and quartz, ceramic or silicon. The first metal layer (not shown) may be made of aluminum, copper, silver, molybdenum, chrome, titanium, tantalum, an alloy thereof or the like, and may be formed into two or more layers having different physical properties. The first metal layer (not shown) may be deposited, for example, by a sputtering process. Subsequently, the first metal layer (not shown) may be patterned by a photo-etching process using a first exposure mask, thereby forming the gate wirings 102 and 104 including the gate line 102 and the gate electrode 104. The gate electrode 104 may be a protrusion protruded from the gate line 102.

Referring now to FIG. 6, the gate insulation layer 112 may be formed on the gate wirings 102 and 104. The gate insulation layer 112 may be formed by a plasma enhanced chemical vapor deposition (PECVD) process, and may include silicon nitride (SiNx), silicon oxide (SiO2) or the like.

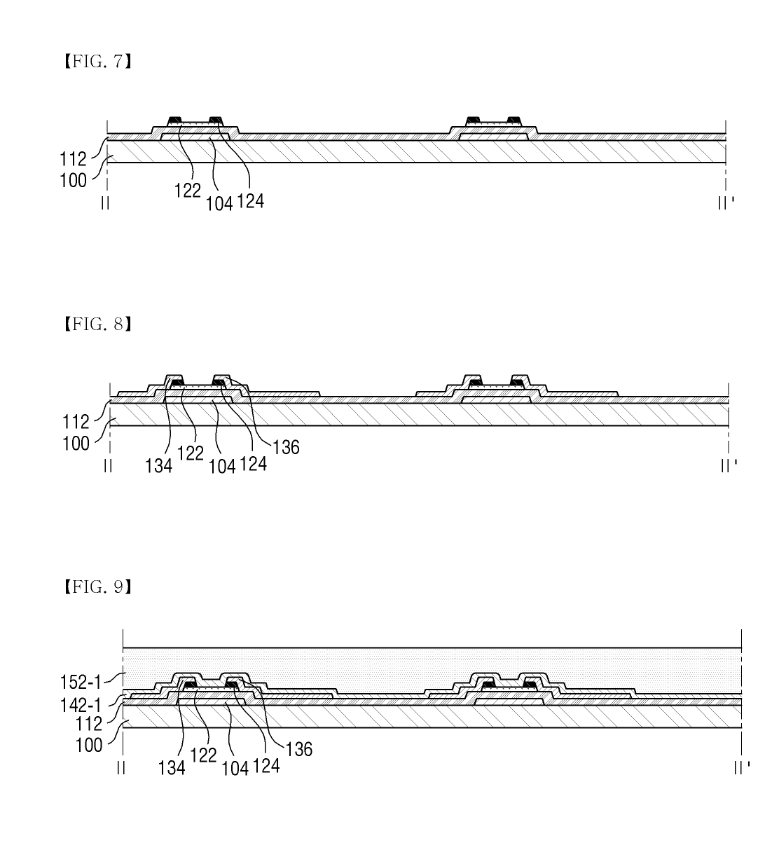

Referring now to FIG. 7, the semiconductor layer 122 and the ohmic contact layer 124 may be formed on the gate insulation layer 112. The semiconductor layer 122 may be made of hydrogenated amorphous silicon or polycrystalline silicon. The semiconductor layer 122 and the ohmic contact layer 124 may be formed through a photo-etching process.

Referring to FIG. 8, the data wirings 132, 134 and 136 including the data line 132 intersecting the gate line 102 so as to define a unit pixel, the source electrode 134 and the drain electrode 136 may be formed on the gate insulation layer 112, the semiconductor layer 122 and the ohmic contact layer 124 through a photo-etching process. Like the gate wirings 102 and 104, the data wirings 132, 134 and 136 may be made of aluminum, copper, silver, molybdenum, chrome, titanium, tantalum, an alloy thereof or the like, and may be formed into two or more layers having different physical properties

In the present embodiment, the semiconductor layer 122, the ohmic contact layer 124 and the data wirings 132, 134 and 136 are exemplified as being formed through a separate photo-etching process, but the present disclosure is not limited thereto, and the semiconductor layer 122, the ohmic contact layer 124 and the data wirings 132, 134 and 136 may be formed through a photo-etching process using a single mask. In this case, residues of the semiconductor layer 122 and the ohmic contact layer 124 may be left under the data line 132. In other words, the semiconductor layer 122 and the ohmic contact layer 124 may be formed into a line. The semiconductor layer 122 may form a thin film transistor together with the gate electrode 104, the source electrode 134 and the drain electrode 136, and may have a channel formed therein.

Referring now to FIG. 9, a first passivation layer 142-1 may be formed on the first substrate 100 on which the thin film transistor is formed. The first passivation layer 142-1 may be made of, for example, an inorganic material such as silicon nitride or silicon oxide, and made of a material including a-Si:C:O, a-Si:O:F and the like through plasma enhanced chemical vapor deposition (PECVD).

Still referring to FIG. 9, a first organic layer 152-1 may be formed on the first passivation layer 142-1. The first organic layer 152-1 may be made of a material having superior planarization characteristics and photosensitivity. The first organic layer 152-1 may be formed by a spin coating process or a slit coating process, or by performing both the spin coating process and the slit coating process at the same time.

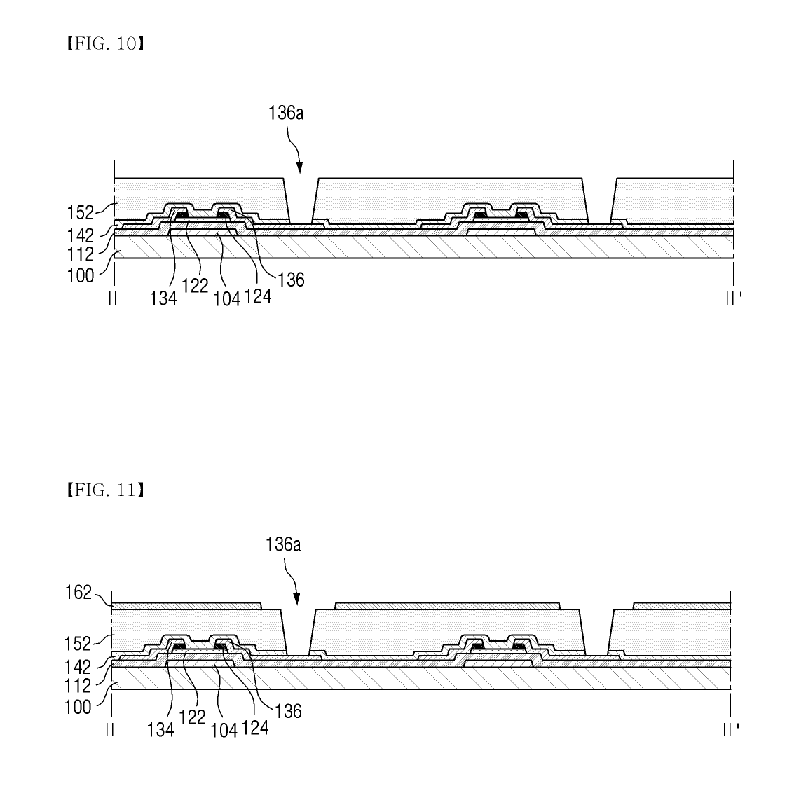

Referring next to FIG. 10, the contact hole 136a for exposing at least a part of the drain electrode 136 may be formed in the first passivation layer 142-1 and the first organic layer 152-1. Specifically, the contact hole 136a may be formed in the first organic layer 152-1 so as to form the first organic layer 152, and subsequently, the contact hole 136a may be formed in the first passivation layer 142-1 so as to form the first passivation layer 142.

Referring next to FIG. 11, the reflective layer 162 may be formed on the first organic layer 152. The reflective layer 162 may serve to reflect light incident from an external source. To this end, the reflective layer 162 may include a highly reflective metal layer, for example, a silver (Ag) or aluminum (Al) metal/reflective layer, but the present disclosure is not limited thereto.

The reflective layer 162 may be formed into a multi-layer structure including two conductive layers having different physical properties. For example, a process of forming the reflective layer 162 may include a step of forming a metal/reflective layer including silver (Ag) and/or aluminum (Al) on the first organic layer 152, and a step of forming a transparent conductive layer such as polycrystalline, single crystalline or amorphous indium tin oxide (ITO) or indium zinc oxide (IZO) on the metal/reflective layer. In this case, the transparent conductive layer may prevent the metal/reflective layer from being oxidized, thereby providing advantages in elongating the life of a display device when compared with the reflective layer 162 made of only a metal/reflective layer.

The reflective layer 162 may include an aperture for interconnecting the pixel electrode 192 and the drain electrode 136, and the aperture may be formed in every pixel. The aperture may have a size larger than the size of the contact hole 136a. In this case, the contact hole 136a may be positioned in the aperture formed in the reflective layer 162 as shown in FIG. 1. The reflective layer 162 may be formed into a single body all over the whole pixel region, excluding the aperture. Since the gate line 102 and the data line 132 are covered by the reflective layer 162, an aperture ratio loss caused by the gate line 102 and the data line 132 may not occur.

The reflective layer 162 may be formed to receive a constant voltage applied thereto. For example, the reflective layer 162 may be electrically connected to the common electrode 202 on the second substrate 200. The reflective layer 162 and the common electrode 202 may be electrically connected with each other by the known conventional various methods, however, a detailed description thereof will be omitted. Thus, a voltage fluctuation caused by the voltages applied to the gate line 102 and the data line 132 may not occur in the reflective layer 162.

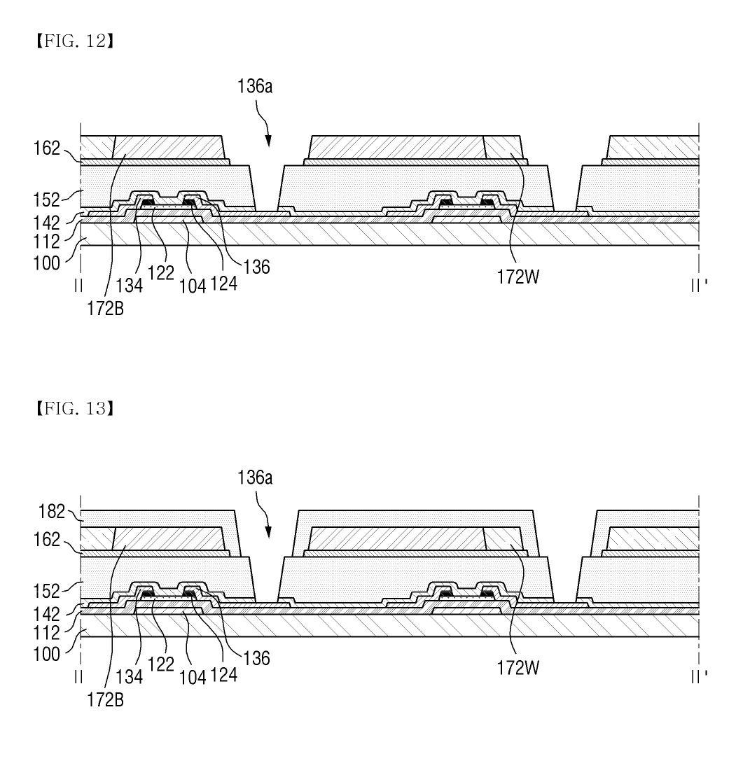

Referring now to FIG. 12, the color filters 172R, 172G, 172B and 172W may be formed on the reflective layer 162. The color filters 172R, 172G, 172B and 172W may include the red color filter 172R, the green color filter 172G, the blue color filter 172B and the white color filter 172W. The color filters 172R, 172G, 172B and 172W may be made of a photosensitive organic material including a pigment. The color filters 172R, 172G, 172B and 172W may be formed by a photo process including exposure and development processes, an inkjet printing process or the like, and various other methods may be applied to form the color filters 172R, 172G, 172B and 172W. The color filters 172R, 172G, 172B and 172W may include an aperture for an interconnection between the pixel electrode 192 and the drain electrode 136. The aperture may have a size larger than the size of the contact hole 136a. In this case, the contact hole 136a may be positioned in the aperture formed in the color filters 172R, 172G, 172B and 172W.

Referring to FIG. 2 to FIG. 4 and FIG. 12, the red color filter 172R and the green color filter 172G may be arranged alternately in a first row in a plane view. The blue color filter 172B and the white color filter 172W may be arranged alternately in the second row adjacent to the first row. One combination C1 of the red, green, blue and white color filters 172R, 172G, 172B and 172W may have a tetragonal shape in a plane view. The red color filter 172R and the green color filter 172G may be arranged in a first row of the one combination C1 and the blue color filter 172B and the white color filter 172W may be arranged in a second row, adjacent to the first row in a column direction, of the one combination C1. Specifically, the one combination C1 of the red, green, blue and white color filters 172R, 172G, 172B and 172W may be arranged repeatedly in a row direction. The combination C1 of the red, green, blue and white color filters 172R, 172G, 172B and 172W and another combination C2 of the red, green, blue and white color filters 172R, 172G, 172B and 172W adjacent to the one combination C1 may be arranged alternately with each other as shown in FIG. 4. For example, the another combination C2 is arranged to be shifted one pixel width from the one combination C1, thus, the red, green, blue and white color filters 172R, 172G, 172B and 172W are substantially arranged in the same column as shown in FIG. 4.

The red, green, blue and white color filters 172R, 172G, 172B and 172W may be arranged consecutively along a column direction as shown in FIG. 2 to FIG. 4. Thus, the red, green, blue and white color filters 172R, 172G, 172B and 172W may be arranged consecutively all over the whole pixel region enclosed by the gate lines 102 and the data line 132, excluding the aperture.

The color filters 172R, 172G, 172B and 172W may be formed in order of the red color filter 172R, the green color filter 172G, the blue color filter 172B and the white color filter 172W. However, this is merely exemplary and the present disclosure is not limited thereto. Since the color filters 172R, 172G, 172B and 172W may be formed in order, boundaries among the color filters 172R, 172G, 172B and 172W may be slanted as shown in FIG. 2 and FIG. 3.

The area of the blue color filter 172B may be wider than the area of the red color filter 172R, the area of the green color filter 172G and the area of the white color filter 172W in the combination C1 of the red, green, blue and white color filters 172R, 172G, 172B and 172W in a plane view. The area of the red color filter 172R and the area of the green color filter 172G may be wider than the area of the white color filter 172W in a plane view. The area of the red color filter 172R and the area of the green color filter 172G may be the same in the combination C1 of the red, green, blue and white color filters 172R, 172G, 172B and 172W in a plane view.

The blue color filter 172B may extend to the white pixel region adjacent to the blue pixel region. Thus, as shown in FIG. 2, the blue color filter 172B may be overlapped with at least a part of a thin film transistor of the white pixel region. Furthermore, the blue color filter 172B may be overlapped with the data line 132 formed between the blue pixel region and the white pixel region.

The reflective layer 162 of the reflective liquid crystal display device 10 may have reddish and yellowish reflection characteristics when compared with white paper. This may cause a user a sense of difference between viewing the screen of the reflective liquid crystal display device and viewing paper, and thus, as shown in FIG. 4, the area of the blue color filter 172B is formed wider than the area of the red color filter 172R and the area of the green color filter 172G, thereby mitigating the reddish and yellowish reflection characteristics of the reflective layer 162 and realizing a color sense similar to those of actual paper.

Furthermore, the luminance of light reflected through the white color filter 172W may be higher than the luminance of light reflected through the red color filter 172R, the green color filter 172G and the blue color filter 172B. Thus, the area of the white color filter 172W may be formed smaller than the area of the red color filter 172R, the green color filter 172G and the blue color filter 172B, thereby effectively mitigating the reddish and yellowish reflection characteristics of the reflective layer 162.

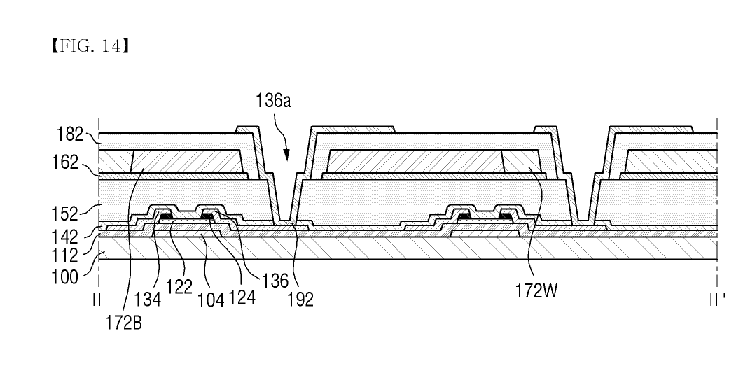

Referring next to FIG. 13, the second organic layer 182 may be formed on the color filters 172R, 172G, 172B and 172W. The second organic layer 182 may be made of a material having superior planarization characteristics and photosensitivity. The second organic layer 182 may be formed by a spin coating process or a slit coating process, or by performing both the spin coating process and the slit coating process at the same time.

The second organic layer 182 may include an aperture for interconnecting the pixel electrode 192 and the drain electrode 136. The aperture may have a size larger than the size of the contact hole 136a. More specifically, the contact hole 136a may be positioned in the aperture formed in the second organic layer 182.

Referring to FIG. 14, the pixel electrode 192 may be formed on the second organic layer 182. Specifically, the pixel electrode 192 may be formed to contact at least a part of the drain electrode 136 exposed through the aperture formed in the second organic layer 182 and the contact hole 136a formed in the first organic layer 152 and the first passivation layer 142. Through such contact, the pixel electrode 192 may be electrically connected to the drain electrode 136.

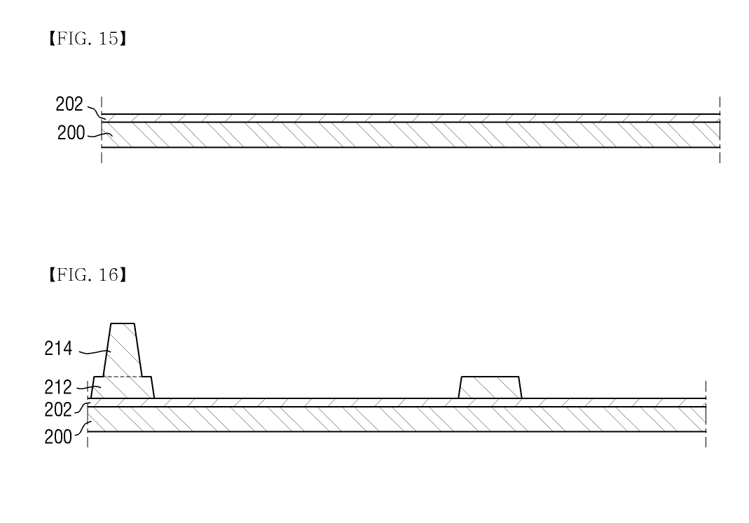

Referring to FIG. 15, the common electrode 202 may be formed on the second substrate 200. The common electrode 202 may be made of a transparent conductive material such as polycrystalline, single crystalline or amorphous indium tin oxide (ITO) or indium zinc oxide (IZO), but the present disclosure is not limited thereto.

Referring to FIG. 16, the light blocking member 212 may be formed on the common electrode 202. The light blocking member 212 may be formed into a lattice configuration to correspond to each of boundaries among the red color filter 172R, the green color filter 172G, the blue color filter 172B and the white color filter 172W in consideration of bonding between the first substrate 100 and the second substrate 200. The light blocking member 212 may be made of a black organic polymer material including black dye or pigment, metal (metallic oxide) such as chrome and chrome oxide, or the like.

Still referring to FIG. 16, the column spacer 214 may be formed on the light blocking member 212. The column spacer 214 may be formed integrally and simultaneously with the light blocking member 212 as shown in FIG. 16. For example, the column spacer 214 and the light blocking member 212 may be formed of the same material through the same patterning process using a half tone mask or slit mask exposure. However, these are merely exemplary, and the present disclosure is not limited thereto.

When the light blocking member 212 is formed into a lattice, the column spacer 214 may be formed at intersecting points of the lattice. However, this arrangement of the column spacers 214 is merely exemplary, and the present disclosure is not limited thereto. The light blocking member 212 between the red pixel region and the green pixel region is not on the same line as the light blocking member 212 between the blue pixel region and the white pixel region as disclosed in FIGS. 2, 3 and 4 because the light blocking member 212 overlaps boundaries between color filters.

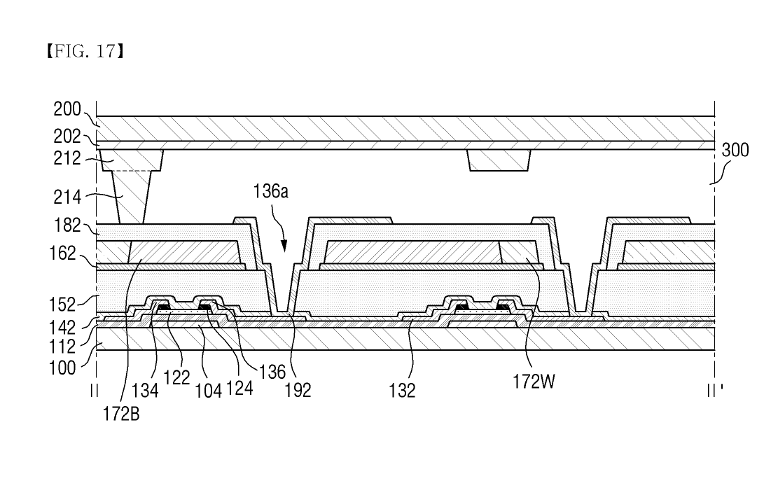

Referring to FIG. 17, an alignment layer (not shown) may be formed on each of the first substrate 100 and the second substrate 200. Subsequently, liquid crystal molecules (not shown) having a positive dielectric anisotropy or a negative dielectric anisotropy may be provided to the first substrate 100 so as to form the liquid crystal layer 300. The first substrate 100 having the liquid crystal layer 300 formed thereon may then be coupled to the second substrate 200.

The reflective liquid crystal display device according to another embodiment of the present inventive concept will now be described.

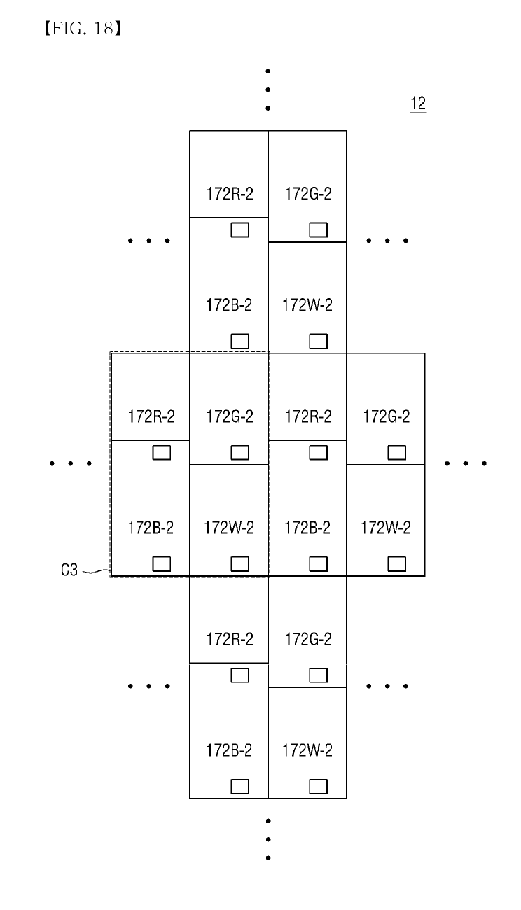

FIG. 18 is a plane view illustrating a structure of a color filter of the reflective liquid crystal display device according to another embodiment of the present inventive concept.

A reflective liquid crystal display device 12 according to another embodiment of the present inventive concept may have color filters 172R-2, 172G-2, 172B-2 and 172W-2 the configurations of which are different from those of the reflective liquid crystal display device 10 described above with reference to FIG. 1 to FIG. 4, and the configurations of the components other than the color filters are the same or similar in the display device 12 and the display device 10. Duplicated descriptions will be omitted and differences from the above-described embodiment will be mainly explained hereinafter.

In the present embodiment, the color filters 172R-2, 172G-2, 172B-2 and 172W-2 may include the red color filter 172R-2, the green color filter 172G-2, the blue color filter 172B-2 and the white color filter 172W-2. Each of the color filters 172R-2, 172G-2, 172B-2 and 172W-2 may be overlapped with one or more pixels.

In the embodiment of FIG. 18, the red color filter 172R-2 and the blue color filter 172B-2 may be alternately arranged in the first column in a plane view. The green color filter 172G-2 and the white color filter 172W-2 may be alternately arranged in the second column adjacent to the first column. One combination C3 of the red, green, blue and white color filters 172R-2, 172G-2, 172B-2 and 172W-2 may have a tetragonal shape in a plane view. The red color filter 172R-2 and the blue color filter 172B-2 may be arranged in a first column of the one combination C3 and the green color filter 172G-2 and the white color filter 172W-2 may be arranged in a second column, adjacent to the first column in a row direction, of the one combination C3. Specifically, the one combination C3 of the red, green, blue and white color filters 172R-2, 172G-2, 172B-2 and 172W-2 may be repeatedly arranged in a row direction. The combination C3 of the red, green, blue and white color filters 172R-2, 172G-2, 172B-2 and 172W-2 and another combination of the red, green, blue and white color filters 172R-2, 172G-2, 172B-2 and 172W-2 adjacent to the one combination C3 may be arranged alternately with each other as shown in FIG. 18. For example, the another combination is arranged to be shifted one pixel width from the one combination C3, thus, the red, green, blue and white color filters 172R-2, 172G-2, 172B-2 and 172W-2 are substantially arranged in the same column as shown in FIG. 4. In one embodiment, the white color filters 172W-2 may be transparent layer.

However, the arrangement of the combinations of the red, green, blue and white color filters 172R-2, 172G-2, 172B-2 and 172W-2 shown in FIG. 18 is merely exemplary, and various other arrangements may be applied to the present disclosure.

The area of the blue color filter 172B-2 may be wider than the area of the red color filter 172R-2, the area of the green color filter 172G-2 and the area of the white color filter 172W-2 in the combination C3 of the red, green, blue and white color filters 172R-2, 172G-2, 172B-2 and 172W-2 in a plane view. The area of the green color filter 172G-2 and the area of the white color filter 172W-2 may be wider than the area of the red color filter 172R-2 in a plane view. The area of the green color filter 172G-2 and the area of the white color filter 172W-2 may be the same in the combination C3 of the red, green, blue and white color filters 172R-2, 172G-2, 172B-2 and 172W-2 in a plane view.

The area ratio of the red, green, blue and white color filters 172R-2, 172G-2, 172B-2 and 172W-2 may be determined in consideration of reflection characteristics of the reflective layer 162. For example, the area ratio of the red, green, blue and white color filters 172R-2, 172G-2, 172B-2 and 172W-2 may be approximately 0.8:1:1.2:1. That is, as the area of the blue color filter 172B-2 may become relatively larger, the area of the red color filter 172R-2 may become relatively smaller. When the pixel electrode 192 has a constant/uniform size regardless of the size of each of the color filters 172R-2, 172G-2, 172B-2 and 172W-2 like those shown in FIG. 1, the blue color filter 172B-2 may extend to a red pixel region adjacent to the blue pixel region. Thus, the blue color filter 172B-2 may be overlapped with at least a part of a thin film transistor in the red pixel region. The blue color filter 172B-2 may be overlapped with the drain electrode 136 of the red pixel. Furthermore, the blue color filter 172B-2 may be overlapped with the gate line 102 interposed between the red pixel region and the blue pixel region.

As shown in FIG. 18, the red color filter 172R-2 may have no aperture. Unlike the red color filter 172R-2, the blue color filter 172B-2 may further include an aperture for an interconnection between the red pixel electrode 192 and the drain electrode 136, thus may include two apertures.

When the area of the green color filter 172G-2 and the area of the white color filter 172W-2 are the same, as shown in the embodiment of FIG. 18, the green color filter 172G-2 and the white color filter 172W-2 may contact with each other in a region corresponding to the gate line 102 interposed between the green pixel electrode 192 and the white pixel electrode 192.

In the embodiment of FIG. 18, the red color filter 172R-2 and the green color filter 172G-2 may contact with each other in the region corresponding to the data line 132 interposed between the red pixel electrode 192 and the green pixel electrode 192.

In the embodiment of FIG. 18, the blue color filter 172B-2 and the green color filter 172G-2 may contact with each other in the region corresponding to the data line 132 interposed between the red pixel electrode 192 and the green pixel electrode 192.

In the embodiment of FIG. 18, the blue color filter 172B-2 and the white color filter 172W-2 may contact with each other in the region corresponding to the data line 132 interposed between the blue pixel electrode 192 and the white.

The reflective layer 162 of the reflective liquid crystal display device 12 may have reddish and yellowish reflection characteristics when compared with white paper. This may cause a user a sense of difference between viewing the screen of the reflective liquid crystal display device and viewing paper, and thus, as shown in FIG. 4, the area of the blue color filter 172B-2 is formed wider than the area of the red color filter 172R-2 and the area of the green color filter 172G-2, thereby mitigating the reddish and yellowish reflection characteristics of the reflective layer 162 and realizing a color sense similar to those of actual paper.

Specifically, as shown in FIG. 18, when the area of the blue color filter 172B-2 is wider than the area of the red color filter 172R-2 and the area of the green color filter 172G-2, and the area of the green color filter 172G-2 is wider than the area of the red color filter 172R-2, the degree of the mitigation of the reddish reflection characteristics in the reflective layer 162 may be higher than the degree of the mitigation of the yellowish reflection characteristics in the reflective layer 162.

Meanwhile, the location of the red color filter 172R-2 and the location of the green color filter 172G-2 may be switched with each other in the combination C3 of the red, green, blue and white color filters 172R-2, 172G-2, 172B-2 and 172W-2. In this case, the area of the blue color filter 172B-2 is wider than the area of the red color filter 172R-2 and the area of the green color filter 172G-2, and the area of the red color filter 172R-2 is wider than the area of the green color filter 172G-2, thus the degree of the mitigation of the yellowish reflection characteristics in the reflective layer 162 may be higher than the degree of the mitigation of the reddish reflection characteristics in the reflective layer 162.

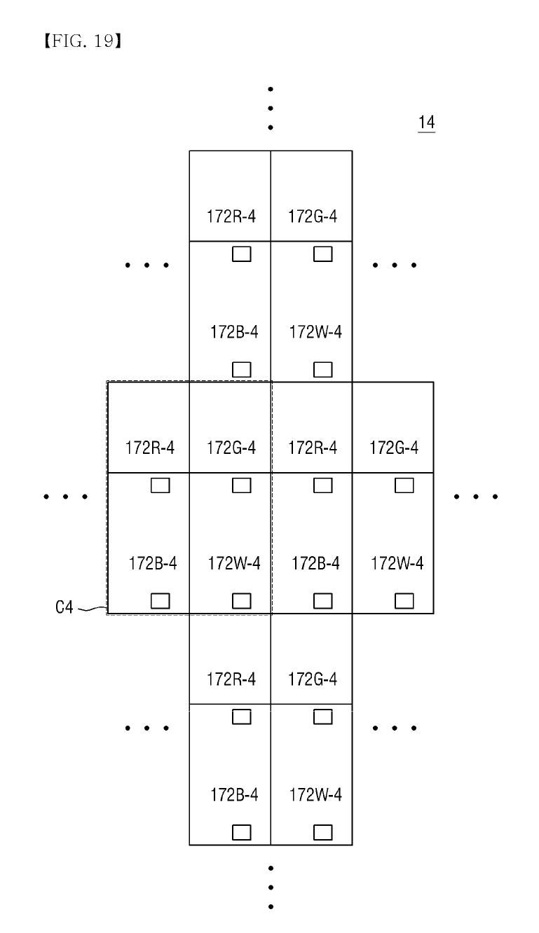

FIG. 19 is a plane view illustrating a structure of a color filter of the reflective liquid crystal display device according to yet another embodiment of the present inventive concept.

A reflective liquid crystal display device 14 according to yet another embodiment of the present inventive concept may have color filters 172R-4, 172G-4, 172B-4 and 172W-4 the configurations of which are different from those of the reflective liquid crystal display device 10 described above with reference to FIG. 1 to FIG. 4, and the configurations of the components other than the color filters are the same or similar in the display device 14 and the display device 10. Duplicated descriptions will be omitted and differences from the above-described embodiment will be mainly explained hereinafter.

In the present embodiment, the color filters 172R-4, 172G-4, 172B-4 and 172W-4 may include the red color filter 172R-4, the green color filter 172G-4, the blue color filter 172B-4 and the white color filter 172W-4. Each of the color filters 172R-4, 172G-4, 172B-4 and 172W-4 may be overlapped with one or more pixels. In the embodiment of FIG. 19, the red color filter 172R-4 and the blue color filter 172B-4 may be arranged alternately in a first column in a plane view. The green color filter 172G-4 and the white color filter 172W-4 may be arranged alternately in a second column adjacent to the first column in a row direction. One combination C4 of the red, green, blue and white color filters 172R-4, 172G-4, 172B-4 and 172W-4 may have a tetragonal shape in a plane view. The red color filter 172R-4 and the blue color filter 172B-4 may be arranged in a first column of the one combination C4 and the green color filter 172G-4 and the white color filter 172W-4 may be arranged in a second column, adjacent to the first column in a row direction, of the one combination C4. Specifically, the one combination C4 of the red, green, blue and white color filters 172R-4, 172G-4, 172B-4 and 172W-4 may be arranged repeatedly in a row direction. The combination C4 of the red, green, blue and white color filters 172R-4, 172G-4, 172B-4 and 172W-4 and another combination of the red, green, blue and white color filters 172R-4, 172G-4, 172B-4 and 172W-4 adjacent to the one combination C4 may be arranged alternately with each other as shown in FIG. 19. For example, the another combination is arranged to be shifted one pixel width from the one combination C4, thus, the red, green, blue and white color filters 172R-4, 172G-4, 172B-4 and 172W-4 are substantially arranged in the same column as shown in FIG. 4.

However, the arrangement of the combinations of the red, green, blue and white color filters 172R-4, 172G-4, 172B-4 and 172W-4 shown in FIG. 19 is merely exemplary, and various other arrangements may be applied to the present disclosure.

The area of the blue color filter 172B-4 and the area of the white color filter 172W-4 may be wider than the area of the red color filter 172R-4 and the area of the green color filter 172G-4 in the combination C4 of the red, green, blue and white color filters 172R-4, 172G-4, 172B-4 and 172W-4 in a plane view. The area of the blue color filter 172B-4 and the area of the white color filter 172W-4 may be the same in the combination C4 of the red, green, blue and white color filters 172R-4, 172G-4, 172B-4 and 172W-4 in a plane view. The area of the red color filter 172R-4 and the area of the green color filter 172G-4 may be the same in the combination C4 of the red, green, blue and white color filters 172R-4, 172G-4, 172B-4 and 172W-4 in a plane view.

The area ratio of the red, green, blue and white color filters 172R-4, 172G-4, 172B-4 and 172W-4 may be determined in consideration of reflection characteristics of the reflective layer 162. For example, the area ratio of the red, green, blue and white color filters 172R-4, 172G-4, 172B-4 and 172W-4 may be approximately 0.8:0.8:1.2:1.2. That is, as the area of the blue color filter 172B-4 may become relatively larger, the area of the red color filter 172R-4 may become relatively smaller, and as the area of the white color filter 172W-4 may become relatively larger, the area of the green color filter 172G-4 may become relatively smaller. When the pixel electrode 192 has a constant/uniform size regardless of the size of each of the color filters 172R-4, 172G-4, 172B-4 and 172W-4 like those shown in FIG. 1, the blue color filter 172B-4 may extend to a pixel red region, and the white color filter 172W-4 may extend to a green pixel region. Thus, the blue color filter 172B-4 may be overlapped with at least a part of a thin film transistor of the red pixel, and the white color filter 172W-4 may be overlapped with at least a part of a thin film transistor of the green pixel. Furthermore, the blue color filter 172B-4 may be overlapped with the gate line 102 interposed between the blue pixel electrode 192 and the red pixel electrode 192 and the white color filter 172W-4 may be overlapped with the gate line 102 interposed between the white pixel electrode 192 4 and the green pixel electrode 192.

As shown in FIG. 19, the red color filter 172R-4 and the green color filter 172G-4 may have no aperture. Unlike the red color filter 172R-4 and the green color filter 172G-4, the blue color filter 172B-4 and the white color filter 172W-4 may further include an aperture for an interconnection between the pixel electrode 192 of an adjacent pixel and the drain electrode 136, thus may include two apertures.

When the area of the red color filter 172R-4 and the area of the green color filter 172G-4 are the same, as shown in the embodiment of FIG. 19, the red color filter 172R-4 and the green color filter 172G-4 may contact with each other in the region corresponding to the data line 132 interposed between the red pixel electrode 192 and the green pixel electrode 192.

When the area of the blue color filter 172B-4 and the area of the white color filter 172W-4 are the same, as shown in the embodiment of FIG. 19, the blue color filter 172B-4 and the white color filter 172W-4 may contact with each other in the region corresponding to the data line 132 interposed between the blue pixel electrode 192 and the white pixel electrode 192.

The reflective layer 162 of the reflective liquid crystal display device 14 may have reddish and yellowish reflection characteristics when compared with white paper. This may cause a user a sense of difference between viewing the screen of the reflective liquid crystal display device and viewing paper, and thus, as shown in FIG. 19, the area of the blue color filter 172B-4 is formed wider than the area of the red color filter 172R-4 and the area of the green color filter 172G-4, thereby mitigating the reddish and yellowish reflection characteristics of the reflective layer 162 and realizing a color sense similar to those of actual paper.

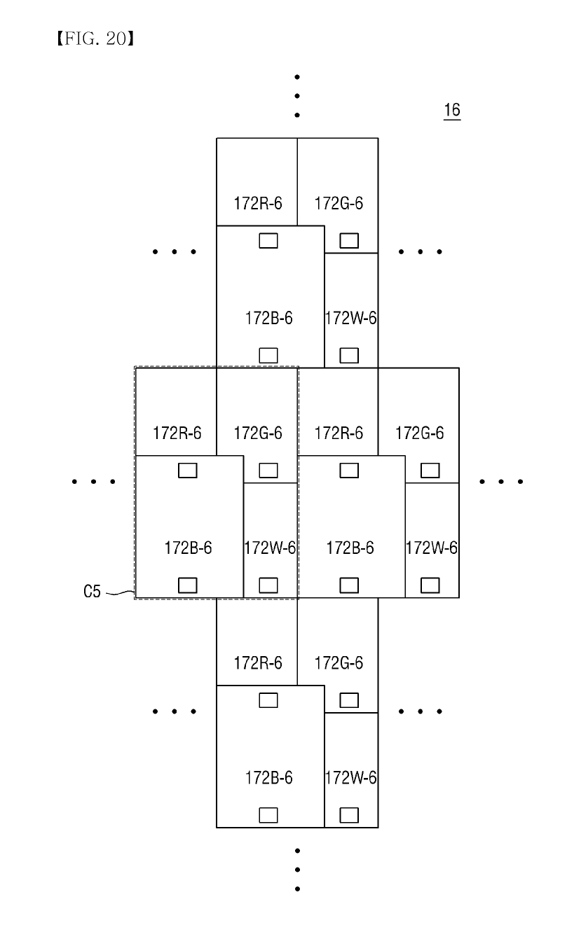

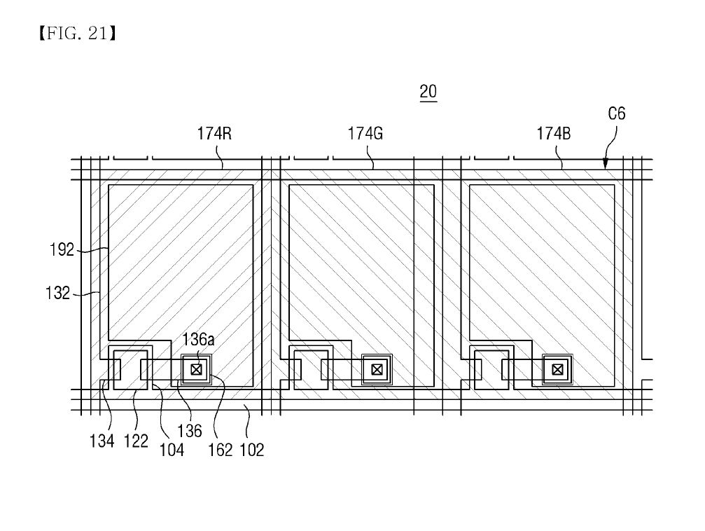

FIG. 20 is a plane view illustrating a structure of a color filter of the reflective liquid crystal display device according to still another embodiment of the present inventive concept.

A reflective liquid crystal display device 16 according to still another embodiment of the present inventive concept may have color filters 172R-6, 172G-6, 172B-6 and 172W-6, the configurations of which are different from those of the reflective liquid crystal display device 10 described above with reference to FIG. 1 to FIG. 4, and the configurations of the components other than the color filters are the same or similar in the display device 16 and the display device 10. Duplicated descriptions will be omitted and differences from the above-described embodiment will be mainly explained hereinafter.

In the present embodiment, the color filters 172R-6, 172G-6, 172B-6 and 172W-6 may include the red color filter 172R-6, the green color filter 172G-6, the blue color filter 172B-6 and the white color filter 172W-6. Each of the color filters 172R-6, 172G-6, 172B-6 and 172W-6 may be overlapped with one or more pixels.

In the embodiment of FIG. 20, one combination C5 of the red, green, blue and white color filters 172R-6, 172G-6, 172B-6 and 172W-6 may have a tetragonal shape in a plane view. The combination unit of the red, green, blue and white color filters 172R-6, 172G-6, 172B-6 and 172W-6 may be repeatedly arranged in a row direction. Specifically, the combination C5 of the red, green, blue and white color filters 172R-6, 172G-6, 172B-6 and 172W-6 may be arranged repeatedly in a row direction. The one combination C5 of the red, green, blue and white color filters 172R-6, 172G-6, 172B-6 and 172W-6 and another combination of the red, green, blue and white color filters 172R-6, 172G-6, 172B-6 and 172W-6 adjacent to the one combination C5 may be arranged alternately with each other in the column direction as shown in FIG. 20. However, the arrangement of the combinations of the red, green, blue and white color filters 172R-6, 172G-6, 172B-6 and 172W-6 shown in FIG. 20 is merely exemplary, and various other arrangements may be applied to the present disclosure.

The area of the blue color filter 172B-6 may be wider than the area of the red color filter 172R-6, the area of the green color filter 172G-6 and the area of the white color filter 172W-6 in the combination C5 of the red, green, blue and white color filters 172R-6, 172G-6, 172B-6 and 172W-6 in a plane view. The area of the red color filter 172R-6, the area of the green color filter 172G-6 and the area of the white color filter 172W-6 may be partially/entirely the same or partially/entirely different from each other in a plane view.

The area ratio of the red, green, blue and white color filters 172R-6, 172G-6, 172B-6 and 172W-6 may be determined in consideration of reflection characteristics of the reflective layer 162. For example, the area ratio of the red, green, blue and white color filters 172R-6, 172G-6, 172B-6 and 172W-6 may be approximately 0.8:0.9:1.5:0.8. That is, as the area of the blue color filter 172B-6 may become relatively larger, the area of the red color filter 172R-6, the area of the green color filter 172G-6 and the area of the white color filter 172W-6 may become relatively smaller. When the pixel electrode 192 has a constant/uniform size regardless of the size of each of the color filters 172R-6, 172G-6, 172B-6 and 172W-6 like those shown in FIG. 1, the blue color filter 172B-6 may extend to pixel regions corresponding respectively to the red pixel, green pixel and the white pixel. Thus, the blue color filter 172B-6 may be overlapped with at least a part of thin film transistors corresponding to the red pixel, the green pixel and the white pixel. Furthermore, the blue color filter 172B-6 may be overlapped with the gate line 102 and the data line 132 intersecting the combination C5 of the red, green, blue and white color filters 172R-6, 172G-6, 172B-6 and 172W-6.

As shown in FIG. 20, the red color filter 172R-6 may have no aperture for an interconnection between the pixel electrode 192 and the drain electrode 136, and the blue color filter 172B-6 may have an aperture for an interconnection between the pixel electrode 192 and the drain electrode 136. Thus the blue color filter 172B-6 may include two apertures for an interconnection between the pixel electrode 192 and the drain electrode 136.

The reflective layer 162 of the reflective liquid crystal display device 16 may have reddish and yellowish reflection characteristics when compared with white paper. This may cause a user a sense of difference between viewing the screen of the reflective liquid crystal display device and viewing paper, and thus, as shown in FIG. 20, the area of the blue color filter 172B-6 is formed wider than the area of the red color filter 172R-6 and the area of the green color filter 172G-6, thereby mitigating the reddish and yellowish reflection characteristics of the reflective layer 162 and realizing a color sense similar to those of actual paper.

In some embodiments, color filters may include a red color filter, a green color filter, a blue color filter and a white color filter. However, this is merely exemplary, and the white color filter may be omitted, and only the red color filter, the green color filter and the blue color filter may be included.

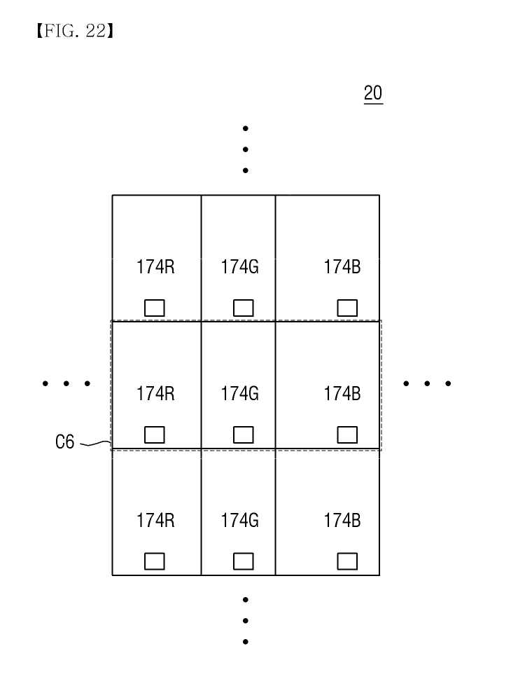

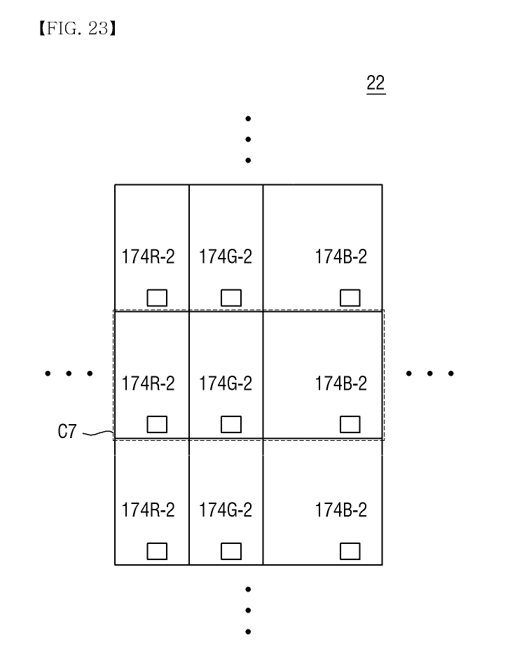

FIG. 21 is layout diagram of a reflective liquid crystal display device according to yet still another embodiment of the present inventive concept. FIG. 22 is a plane view illustrating a structure of a color filter of the reflective liquid crystal display device according to yet still another embodiment of the present inventive concept.

A reflective liquid crystal display device 20 according to yet still another embodiment of the present inventive concept may have color filters 174R, 174G, 174B and 174W the configurations of which are different from those of the reflective liquid crystal display device 10 described above with reference to FIG. 1 to FIG. 4, and the configurations of the components other than the color filters are the same or similar in the display device 20 and the display device 10. Duplicated descriptions will be omitted and differences from the above-described embodiment will be mainly explained hereinafter.

In the present embodiment, the color filters 174R, 174G and 174B may include the red color filter 174R, the green color filter 174G and the blue color filter 174B. Each of the color filters 174R, 174G and 174B may be overlapped with one or more pixels. The color filters 174R, 174G and 174B may include an aperture for an interconnection between the pixel electrode 192 and the drain electrode 136.

In the present embodiment, the red color filter 174R, the green color filter 174G and the blue color filter 174B may be sequentially arranged repeatedly alternately in the same row in a plane view. The red color filter 174R, the green color filter 174G and the blue color filter 174B may be consecutively arranged in a row direction. One combination C6 of the red, green and blue color filters 174R, 174G and 174B may have a tetragonal shape in a plane view. The one combination C6 of the red, green and blue color filters 174R, 174G and 174B may be arranged repeatedly in a column direction and a row direction. However, the arrangement of the combinations of the red, green and blue color filters 174R, 174G and 174B shown in FIG. 22 is merely exemplary, and various other arrangements may be applied to the present disclosure.

The area of the blue color filter 174B may be wider than the area of the red color filter 174R and the area of the green color filter 174G in the one combination C6 of the red, green and blue color filters 174R, 174G and 174B in a plane view. The area of the red color filter 174R may be wider than the area of the green color filter 174G in a plane view.

The area ratio of the red, green and blue color filters 174R, 174G and 174B may be determined in consideration of reflection characteristics of the reflective layer 162. For example, the area ratio of the red, green and blue color filters 174R, 174G and 174B may be approximately 1:0.8:1.2. That is, as the area of the blue color filter 174B may become relatively larger, the area of the green color filter 174G may become relatively smaller. When the pixel electrode 192 has a constant/uniform size regardless of the size of each of the color filters 174R, 174G and 174B as shown in FIG. 21, the blue color filter 174B may extend to a green pixel region. Thus, the blue color filter 174B may be overlapped with the data line 132 interposed between the blue pixel electrode 192 and the green pixel electrode 192.

In the present embodiment, the red color filter 174R and the green color filter 174G may contact with each other in the region corresponding to the data line 132 interposed between the red pixel electrode 192 and the green pixel electrode 192.

The reflective layer 162 of the reflective liquid crystal display device 20 may have reddish and yellowish reflection characteristics when compared with white paper. This may cause a user a sense of difference between viewing the screen of the reflective liquid crystal display device and viewing paper, and thus, as shown in FIG. 22, the area of the blue color filter 174B is formed wider than the area of the red color filter 174R and the area of the green color filter 174G, thereby mitigating the reddish and yellowish reflection characteristics of the reflective layer 162 and realizing a color sense similar to those of actual paper.

Specifically, as shown in FIG. 22, when the area of the blue color filter 174B is wider than the area of the red color filter 174R and the area of the green color filter 174G, and the area of the red color filter 174R is wider than the area of the green color filter 174G, the degree of the mitigation of the yellowish reflection characteristics in the reflective layer 162 may be higher than the degree of the mitigation of the reddish reflection characteristics in the reflective layer 162.

Meanwhile, the location of the red color filter 174R and the location of the green color filter 174G may be switched with each other in the combination C6 of the red, green and blue color filters 174R, 174G and 174B. In this case, the area of the blue color filter 174B is wider than the area of the red color filter 174R and the area of the green color filter 174G, and the area of the green color filter 174G is wider than the area of the red color filter 174R, thus the degree of the mitigation of the reddish reflection characteristics in the reflective layer 162 may be higher than the degree of the mitigation of the yellowish reflection characteristics in the reflective layer 162.

FIG. 23 is a plane view illustrating a structure of a color filter of a reflective liquid crystal display device according to yet still another embodiment of the present inventive concept.

A reflective liquid crystal display device 22 according to yet still another embodiment of the present inventive concept may have color filters 174R-2, 174G-2 and 174B-2 the configurations of which are different from those of the reflective liquid crystal display device 20 described above with reference to FIG. 21 and FIG. 22, and the configurations of the components other than the color filters are the same or similar in the display device 22 and the display device 20. Duplicated descriptions will be omitted and differences from the above-described embodiment will be mainly explained hereinafter.

In the present embodiment, the color filters 174R-2, 174G-2 and 174B-2 may include the red color filter 174R-2, the green color filter 174G-2 and the blue color filter 174B-2. Each of the color filters 174R-2, 174G-2 and 174B-2 may be overlapped with one or more pixels. The color filters 174R-2, 174G-2 and 174B-2 may include an aperture for an interconnection between the pixel electrode 192 and the drain electrode 136.

In the present embodiment, the red color filter 174R-2, the green color filter 174G-2 and the blue color filter 174B-2 may be sequentially arranged repeatedly alternately in the same row in a plane view. The red color filter 174R-2, the green color filter 174G-2 and the blue color filter 174B-2 may be consecutively arranged in a row direction. One combination C7 of the red, green and blue color filters 174R-2, 174G-2 and 174B-2 may have a tetragonal shape in a plane view. The one combination C7 of the red, green and blue color filters 174R-2, 174G-2 and 174B-2 may be arranged repeatedly alternately. Specifically, the one combination C7 of the red, green and blue color filters 174R-2, 174G-2 and 174B-2 may be arranged repeatedly in a column direction and a row direction. However, the arrangement of the combinations of the red, green and blue color filters 174R-2, 174G-2 and 174B-2 shown in FIG. 23 is merely exemplary, and various other arrangements may be applied to the present disclosure.

The area of the blue color filter 174B-2 may be wider than the area of the red color filter 174R-2 and the area of the green color filter 174G-2 in the combination C7 of the red, green and blue color filters 174R-2, 174G-2 and 174B-2 in a plane view. The area of the red color filter 174R-2 and the area of the green color filter 174G-2 may be the same in a plane view.

The area ratio of the red, green and blue color filters 174R-2, 174G-2 and 174B-2 may be determined in consideration of reflection characteristics of the reflective layer 162. For example, the area ratio of the red, green and blue color filters 174R-2, 174G-2 and 174B-2 may be approximately 0.9:0.9:1.2. That is, as the area of the blue color filter 174B-2 may become relatively larger, the area of the red color filter 174R-2 and the area of the green color filter 174G may become relatively smaller. When the pixel electrode 192 has a constant/uniform size regardless of the size of each of the color filters 174R-2, 174G-2 and 174B-2 as shown in FIG. 21, the blue color filter 174B-2 may extend to a green pixel region and the red pixel region. Thus, the blue color filter 174B-2 may be overlapped with the data line 132 interposed between the blue pixel electrode 192 and the green pixel electrode 192, and the data line 132 interposed between the blue pixel electrode 192 and the red pixel electrode 192.

The reflective layer 162 of the reflective liquid crystal display device 22 may have reddish and yellowish reflection characteristics when compared with white paper. This may cause a user a sense of difference between viewing the screen of the reflective liquid crystal display device and viewing paper, and thus, as shown in FIG. 23, the area of the blue color filter 174B-2 is formed wider than the area of the red color filter 174R-2 and the area of the green color filter 174G-2, thereby mitigating the reddish and yellowish reflection characteristics of the reflective layer 162 and realizing a color sense similar to those of actual paper.

Although exemplary embodiments of the present inventive concept have been described, it is understood that the inventive concept should not be limited to these exemplary embodiments, and those skilled in the art will appreciate that many other variations and adaptations can be made without departing from the substantial features of the exemplary embodiments of the present inventive concept. For example, variations can be made to each component described in detail in the exemplary embodiments of the present inventive concept. Moreover, differences related to such variations and adaptations should be construed as being embraced within the scope of the present inventive concept defined by the appended claims.

What is claimed is:

1. A reflective liquid crystal display device comprising:
a first substrate and a second substrate facing each other;
a liquid crystal layer interposed between the first substrate and the second substrate;
a plurality of gate lines and a plurality of data lines disposed on the first substrate and intersecting each other so as to define unit pixels;
a reflective layer disposed on the gate lines and the data lines; and
a color filter disposed on the reflective layer,
wherein the color filter includes a red color filter, a green color filter and a blue color filter,
wherein the blue color filter has an area larger than an area of the red color filter and an area of the green color filter, and
wherein the blue color filter disposed on a first pixel and a second pixel adjacent to the first pixel.

2. The reflective liquid crystal display device of claim 1, wherein the pixels defined by the plurality of gate lines and the plurality of data lines have a uniform size.

3. The reflective liquid crystal display device of claim 1, wherein the blue color filter is overlapped with two or more thin film transistors.

4. The reflective liquid crystal display device of claim 1, wherein the area of the red color filter and the area of the green color filter are the same.

5. The reflective liquid crystal display device of claim 1, wherein the color filter further includes a white color filter, and the area of the blue color filter is larger than an area of the white color filter.

6. The reflective liquid crystal display device of claim 5, wherein the area of the red color filter and the area of the green color filter are larger than the area of the white color filter.

7. The reflective liquid crystal display device of claim 1, wherein the color filter further includes a white color filter, and the area of the blue color filter is the same as an area of the white color filter.

8. The reflective liquid crystal display device of claim 1, wherein the color filter further includes a white color filter, and the red color filter, the green color filter, the blue color filter and the white color filter are arranged in two columns by two rows configuration, and the blue color filter and the white color filter are disposed in the same row.

9. The reflective liquid crystal display device of claim 1, further comprising a first organic layer and a second organic layer,
wherein the reflective layer is disposed on the first organic layer, and the second organic layer is disposed on the color filter.

10. The reflective liquid crystal display device of claim 1, further comprising a light blocking member disposed on the second substrate,
wherein the light blocking member is disposed on a region corresponding to a boundary between the color filters.

11. The reflective liquid crystal display device of claim 1, further comprising a common electrode disposed on the second substrate,
wherein the common electrode and the reflective layer have same electrical potential.

12. A method of manufacturing a reflective liquid crystal display device, the method comprising:
forming a plurality of gate lines and a plurality of data lines intersecting each other on a first substrate so as to define unit pixels;
forming a reflective layer on the gate lines and the data lines; and
forming a color filter on the reflective layer,
wherein the color filter includes a red color filter, a green color filter and a blue color filter,
wherein the blue color filter has an area larger than an area of the red color filter and an area of the green color filter, and
wherein the blue color filter disposed on a first pixel and a second pixel adjacent to the first pixel.

13. The method of claim 12, wherein the pixels defined by the plurality of gate lines and the plurality of data lines have a uniform size.

14. The method of claim 12, wherein the blue color filter is overlapped with two or more thin film transistors.

15. The method of claim 12, wherein the color filter further includes a white color filter, and the area of the blue color filter is larger than an area of the white color filter.

16. The method of claim 12, further comprising:
forming a first organic layer on the gate lines and the data lines; and
forming a second organic layer on the color filter.

17. The method of claim 16, further comprising forming a pixel electrode on the second organic layer.

18. The method of claim 12, further comprising:
forming a common electrode on a second substrate; and
forming a light blocking member on the common electrode,
wherein the light blocking member is disposed on a region corresponding to a boundary between the color filters.

19. The method of claim 18, further comprising forming a column spacer on the light blocking member.

20. The method of claim 19, wherein the light blocking member and the column spacer are formed integrally with each other.
